(19) United States
(12) Patent Application Publication
(10) Pub. No.: US 2023/0365374 A1
(43) Pub. Date: Nov. 16, 2023

(54) METHOD FOR WINDING A FILAMENT FOR AN ADDITIVE MANUFACTURING DEVICE

(71) Applicants: ECOLE NATIONALE SUPERIEURE D'ARTS ET METIERS (ENSAM), PARIS (FR); SAFRAN, Paris (FR); CENTRE NATIONAL DE LA RECHERCHE SCIENTIFIQUE, PARIS CEDEX 16 (FR); CONSERVATOIRE NATIONAL DES ARTS ET METIERS, PARIS CEDEX 03 (FR)

(72) Inventors: Alexis THEZE, MOISSY-CRAMAYEL (FR); Alain GUINAULT, CREGY LES MEAUX (FR); Gilles REGNIER, L'HAY-LES-ROSES (FR)

(21) Appl. No.: 18/028,421

(22) PCT Filed: Sep. 24, 2021
(86) PCT No.: PCT/FR2021/051653

§ 371 Date: Mar. 24, 2023

(30) Foreign Application Priority Data
Sep. 25, 2020 (FR) FR2009798

(51) Int. Cl. B65H 54/02; B22F 10/22; B33Y 40/00; B22F 12/50

(52) U.S. Cl. CPC B65H 54/02; B22F 10/22; B33Y 40/00; B22F 12/50

(57) ABSTRACT

The present invention relates to an assembly for a turbomachine turbine extending along an axis (X), comprising: —an ejection cone (100) comprising a radially outer annular wall (102) defining a flow duct for a flow of hot gases and a sound box radially arranged inside the outer annular wall (102), the sound box comprising a radially inner annular wall (104), —a connecting member (106) intended to be axially inserted between the exhaust housing and the ejection cone (100), the connecting member (106) comprising an upstream annular flange (108) intended to be attached to the exhaust housing and a plurality of downstream securing tabs (110) connected to the inner annular wall (104), —an annular sealing shroud (112) comprising an upstream portion surrounding the securing tabs (110) of the connecting member (106) so as to cover the spaces circumferentially located between the securing tabs (110) and axially located between the upstream annular flange (108) of the connecting member (106) and the radially inner annular wall (104).

### TECHNICAL FIELD OF THE INVENTION

The present document relates to a method for winding a filament with a high metal powder charge rate. This filament is intended for an additive manufacturing device.

### PRIOR ART

When making parts by additive manufacturing, a filament is melted and solidifies in order to make said parts layer-by-layer. The storage of the consumable filament is done around a coil.

Conventionally in a fused filament fabrication process also called “Fused Filament Fabrication” (FFF), filaments are used comprising a binder including polymers such as polylactic acid (PLA), acrylonitrile butadiene styrene (ABS), polycarbonate, nylon, glycolized polyethylene terephthalate (PETG), etc. In general, these filaments are not filled with metal powder. Sometimes, they are slightly filled, such as with carbon fibers for example, to reinforce the final properties of the part. In the case of the additive manufacturing of metal parts via the FFF process, the filament reaches an extremely high metal powder filling rate because it is intended to produce a composite part called “green part”. This part will undergo several post-printing operations in order to remove the polymer portion of the part and densify it to finally obtain an entirely metallic part.

In general, the FFF process comprises an amount of metal powder greater than or equal to 80% and preferably between 85 and 91% by mass. The filaments typically have a diameter comprised between 1.5 and 5 mm and preferably between 1.65 and 1.85 mm.

This process is very similar to a metal powder injection molding process, also called “Metal Injection Molding” (MIM). The difference between the FFF process and the MIM process is that, in the FFF process, the part is printed and not injected by means of a press and a mold like in the MIM process.

It is important to understand the MIM process as a whole in order to understand the necessity and the importance, in the FFF process, of having a filament with an amount of metal powder greater than or equal to 80% by mass.

FIG. 1 conventionally illustrates the MIM process 1. In this MIM process 1, the binder 2 and the metal powder 4 are mixed in a mixer 6, then the whole is extruded in an extruder 8. A filament 10 is obtained and is injected with a press 12. A green part 14 is obtained.

FIG. 2 illustrates the FFF process 3. In this FFF process 3, a filament 10 is obtained in the same manner as in the MIM process 1. However, in the FFF process 3, the filament 10 does not pass through a press 12 but a green part 14 is printed by means of a 3D printer 16 in which a filament 10 filled with metal powder is loaded.

Afterwards, in both the MIM process 1 illustrated in FIG. 1 and the FFF process 3 illustrated in FIG. 2, the green part 14 passes through a first debinding furnace 18. As its name suggests, this first operation will remove the polymer binder. In this step, the polymer portion contained in the part is removed. At the end of this step, the debinded portion 20 consists almost exclusively of metal powder. There remains just a little binder between the powder grains to hold the part. If all of the binder were removed at this step, the part would collapse. At the end of this step, sintering 22 occurs. At this stage, we talk about a brown part 24. Once 90% of the binder has been evacuated, the fragile and porous part passes through a second sintering furnace which will densify the part. At the end of this sintering step, the part will be entirely metallic and the porosities left by the evacuation of the binder during the debinding step will disappear almost completely. The counterpart is that the volume of the room will decrease. Thus, the greater the proportion of binder in the green part, the greater will be the variation in the final volume of the part. For this reason, one look to print or inject a part with the highest metal content to minimize volume variations and more easily predict the final geometry of the part. Shrinkage is generally isotropic on the 3 axes.

Thus, FIG. 3 illustrates a volume variation between a green part 14 in FIG. 3A and a sintered part or brown part 24 in FIG. 3B. The higher the metal powder filling rate, the lower will be the volume variation. Yet, a high metal powder filling rate makes the filament very fragile.

FIG. 4 illustrates the evolution of the bending stress a in Mega Pascal (MPa) as a function of the strain rate e.

Three-point bending tests on such a filament with a high metal powder filling rate show that, at room temperature, i.e. at a temperature comprised between 18 and 22° C., the elasticity of the filament is very low and lower than or equal to 1%.

From FIG. 4, one could notice that the bending stress a increases rapidly until reaching 17 MPa for a strain rate of 0.4%. Then, for a strain higher than 0.4%, the bending stress a drops suddenly, indicating a break-up of said filament.

Under such conditions, as illustrated in FIG. 5, the filament is particularly brittle at room temperature. It then becomes impossible to wind and unwind the filament onto a coil of an additive manufacturing device without any risk of cracks 102 or break-up of the filament. A break-up of the filament or a cracking of the filament during winding of said filament around the coil makes it unusable. Indeed, in the FFF process, the printing head and the drive system need a continuous filament with a constant section to guarantee a regular flow rate. To overcome this difficulty, it is known to protect said filament 104 by disposing a polymer skin 106 around the filament as illustrated in FIG. 6. The addition of this 50 μm thick polymer skin 106 around the filament 104 allows reaching the radius of curvature necessary for winding thereof and facilitates printing of the material because it makes it less brittle and less viscous. Nonetheless, this solution increases the matrix content in the filament 4 which induces other difficulties such as the increase in residual stresses in the part formed from such a filament. A higher proportion of binder results in more shrinkage and makes it less predictable. The presence of a polymer skin around the filament can cause an uneven distribution of the powder and of the binder in the part.

Hence, it is important to provide a technical solution that does not modify the constitution of the filament and guarantees its integrity, i.e. no cracks or breaks are present in this filament.

### PRESENTATION OF THE INVENTION

The present document relates to a method for winding a filament for an additive manufacturing device comprising the steps of:
providing a filament filled with at least 80% metal powder by mass;
heating said filament up to a temperature of at least 70° C. and keeping said filament at said temperature;
winding said filament around the axis of a coil, preferably metallic, the diameter of the coil being in the empty state larger than or equal to a diameter of 120 mm.

Under such conditions, it becomes possible to wind the filament without generating a break-up or crack in said filament. This allows placing oneself under conditions of favorable elasticity. In addition, the coil being preferably made of metal, this prevents it from deforming with heat.

Said diameter of the coil may be comprised between 100 and 140 mm, preferably between 120 and 140 mm.

Said filament may be heated to a temperature comprised between 70 and 140° C., preferably between 70 and 90° C.

The present document relates to an installation for winding a filament onto a coil for an additive manufacturing device comprising:
a filament extruder;
stretching aids;
means for heating said filament to a temperature of at least 70° C.;
drive means;
means for winding said filament around the coil, preferably metallic, the diameter of the coil of which in the empty state is larger than or equal to a diameter of 100 mm.

The heating means may intervene between the stretching means and the winding.

The stretching means may comprise a drawing belt.

The means for heating said filament may comprise means for blowing air at said temperature.

The means for heating said filament may include an infrared heating means.

The drive means may include at least one drive roller.

### BRIEF DESCRIPTION OF THE FIGURES

FIG. 1 represents a metal powder injection molding process, also called “Metal Injection Molding” (MIM);

FIG. 2 represents a fused filament fabrication process, also called “Fused Filament Fabrication” (FFF);

FIG. 3 represents a volume variation between a green part in FIG. 3A and a sintered part in FIG. 3B.

FIG. 4 represents a three-point bending test on a filament at room temperature and more specifically the evolution of the bending stress a of said filament in Mega Pascal (MPa) as a function of the strain rate e;

FIG. 5 represents an example of a damaged filament comprising cracks;

FIG. 6 represents a filament surrounded by a polymer skin;

FIG. 7 represents an extrusion device or industrial extrusion line for a filament according to the invention;

FIG. 8 represents in FIG. 12A a coil according to the invention and in FIG. 12B a conventional coil.

FIG. 9 represents the evolution of the elastic modulus G′ as a function of the temperature T for a filament during dynamic thermomechanical analysis tests (DMTA) according to the invention;

FIG. 10 represents three-point bending tests on a filament at a temperature T of 80° C. and more specifically the evolution of the bending stress a of said filament in Mega Pascal (MPa) as a function of the strain rate ε according to the invention;

FIG. 11 represents in FIG. 11A the evolution of the bending stress σ of said filament in Mega Pascal (MPa) as a function of the strain rate ε and in FIG. 11B, the evolution of the minimum radius of curvature R in millimeters (mm) of the central roll of the coil such that the filament is not damaged as a function of the strain rate ε according to the invention;

FIG. 12 represents a diagram illustrating the obtainment of a radius of curvature as a function of a strain during a three-point bending test.

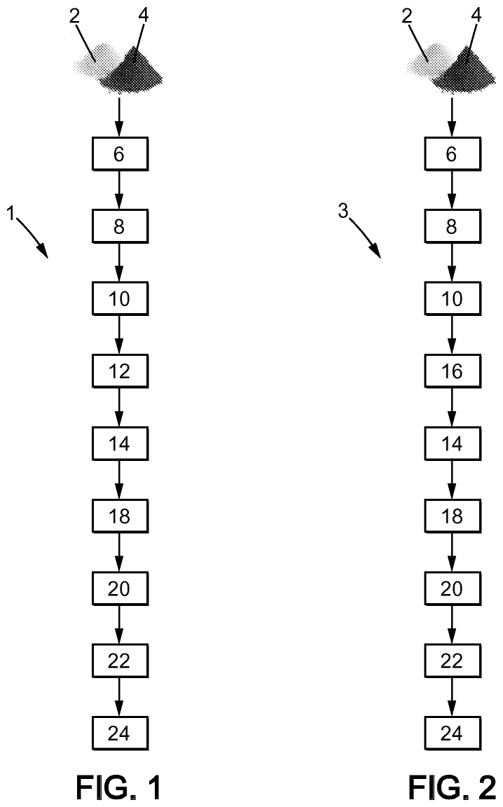

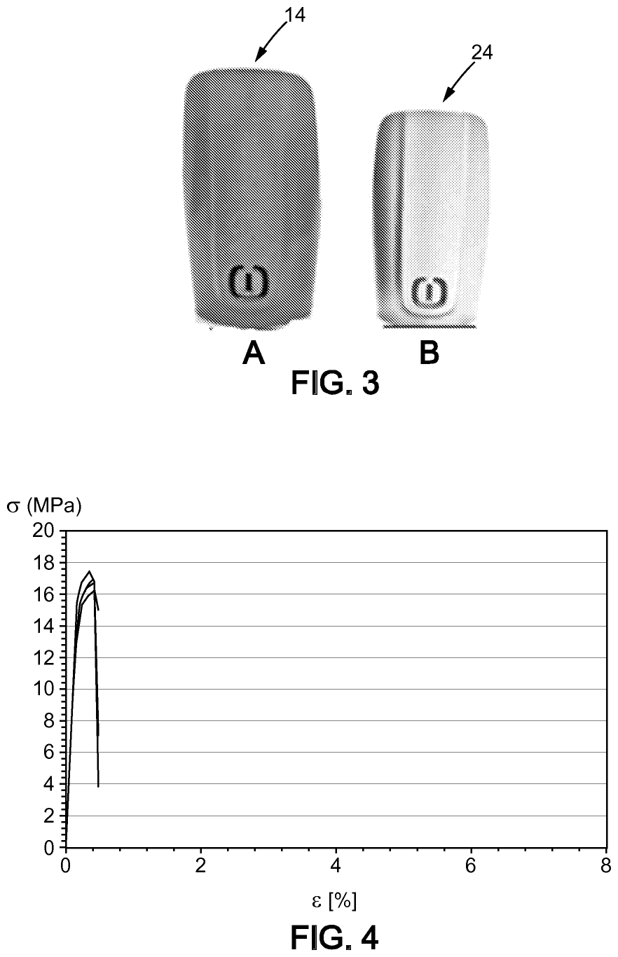

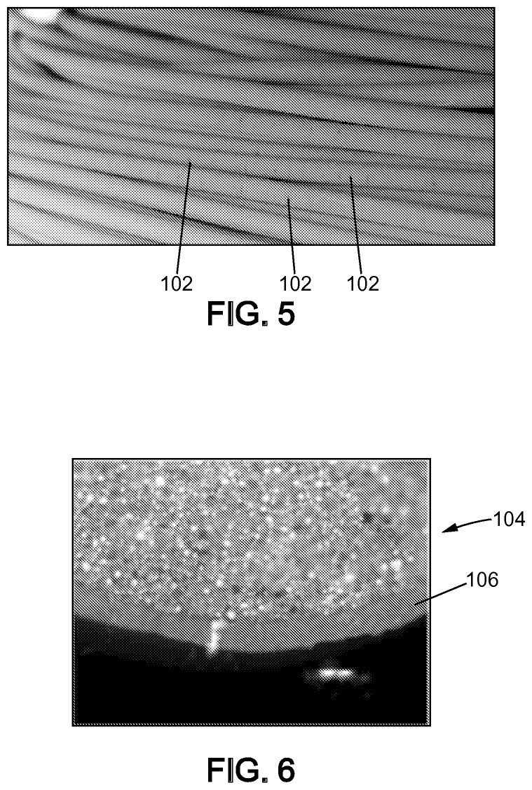

### DETAILED DESCRIPTION OF THE INVENTION

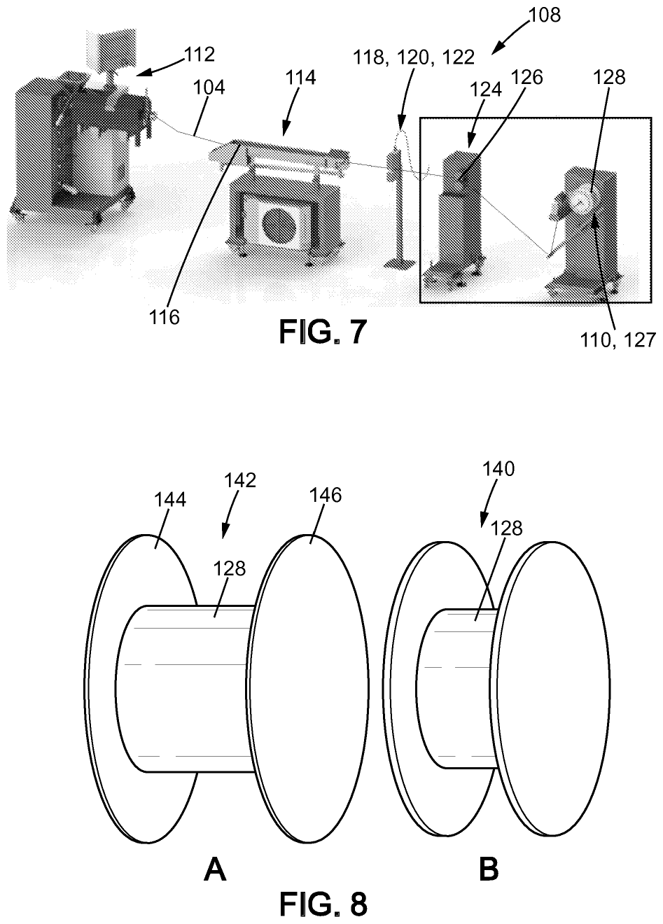

The present document falls in the context of an additive manufacturing device allowing building a part layer-by-layer, by depositing a molten filament which solidifies while cooling. FIG. 7 illustrates an installation 108 for extruding a filament 104 and winding it onto a coil 110 for subsequent use in an additive manufacturing device.

In such an installation, the filament 104 is produced by means of an extruder 112. This filament 104 has a diameter comprised between 1.5 and 5 mm. It comprises between one and three polymers and is filled with at least 80% metal powder by mass.

Afterwards, the filament 104 is stretched by stretching means 114. These stretching means 114 comprise a drawing belt 116. The filament 104 is then heated by heating means 118 to a temperature of at least 80° C. These heating means 118 comprise means for heating air to said temperature 120 and/or an infrared heating means 122. Thus, the filament 104 is heated and kept at said temperature: one of the compounds of the binder is kept in the molten state to soften the filament. Afterwards, the filament is driven by drive means 124 towards a coil 110. These drive means comprise at least one drive roller 126.

The filament 104 is then wound by winding means 127 around a coil 110. This coil includes a central roll 128 or cylindrical portion with a circular base around which the filament is wound.

The central roll 128 includes an external perimeter of its base which is inscribed within a circle so that this central roll 128 could be a cylindrical portion with a polygonal base. This central roll 28 has a diameter larger than or equal to 100 mm, preferably comprised between 100 and 140 mm, still more preferably between 120 and 140 mm.

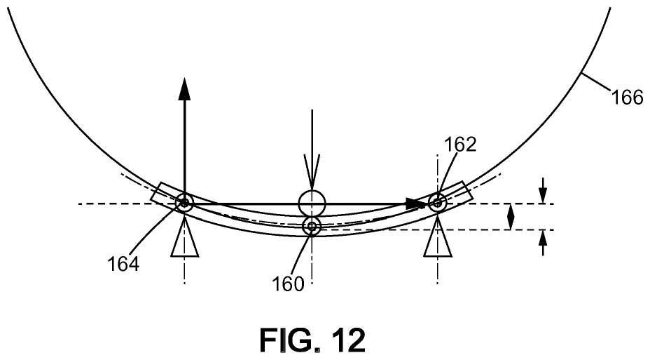

FIG. 8 illustrates a comparison between a conventional coil 140 in FIG. 12B and a coil 142 used to wind the filament filled with metal powder according to the invention in FIG. 12A. The diameter of the central roll 128 is 120 mm on the coil 142 according to the invention which is preferably made of metal and which is illustrated in FIG. 12A while the diameter of the central roll 128 is smaller for the conventional coil 140 in FIG. 12B. The coil 142 according to the invention includes a first cylindrical flange 144 and a second cylindrical flange 146 each having a diameter larger than that of the central roll 128.

In operation, thanks to these elastic properties, the filament can be wound without breaking or cracking starting from a temperature of at least 70° C., preferably between 70 and 90° C. Once wound hot, as it cools down, the filament keeps the shape of the winding. To unwind it without breaking or cracking it, it is necessary to heat the filament again up to a temperature of at least 70° C., preferably comprised between 70 and 140° C., still more preferably between 70 and 90° C.

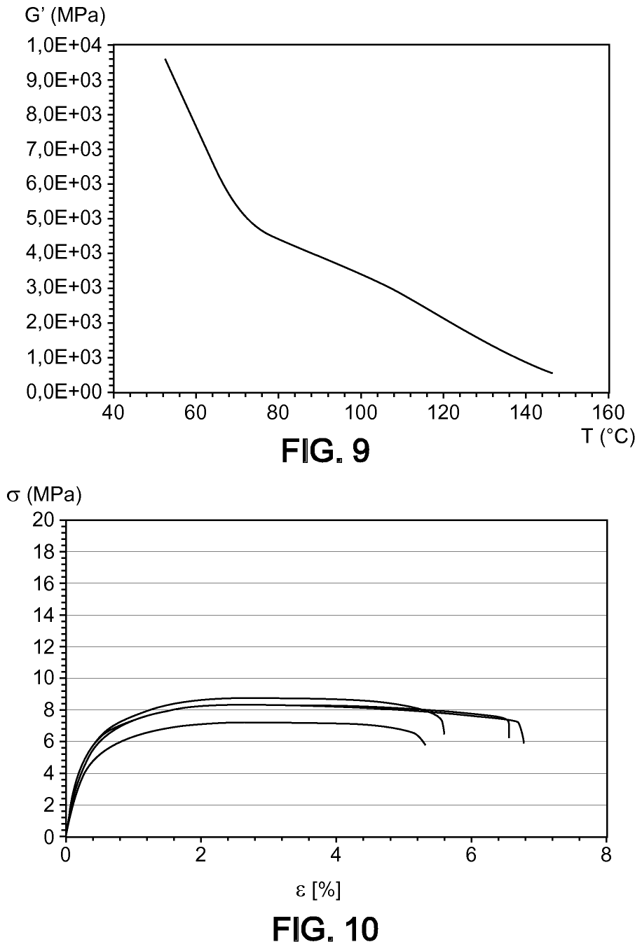

FIG. 9 illustrates the evolution of the elastic modulus G′ in Mega Pascal (MPa) of said filament as a function of the temperature T during a dynamic thermomechanical analysis test, also called DMTA. This elastic modulus G′ teaches about the rigidity and the elastic component of the material. The elastic modulus G′ has a value of 9.5×10³ MPa for a temperature of about 50° C. and decreases as the temperature increases. Softening occurs at temperatures comprised between 80 and 140° C. conferring on said filament the properties necessary for winding without breaking or cracking around the coil. At a temperature T of 80° C., the elastic modulus G′ drops to 4.4×10³ MPa and to less than 10³ MPa at a temperature T of 140° C.

FIG. 10 illustrates the three-point bending tests carried out on said filament at a temperature of 80° C. and more specifically this FIG. 10 shows the evolution of the bending stress a in Mega Pascal (MPa) as a function of the strain rate e. Four curves are presented corresponding to the same tests carried out four times. In contrast with the results of three-point bending tests carried out at room temperature in FIG. 4, the bending stress a is herein lower. A plateau is reached starting from about 1% of strain rate for which the bending stress a is comprised between 7 and 9 MPa. Thus, even at strain rates of 5%, there is no rupture, break-up of the filament in response to these stresses.

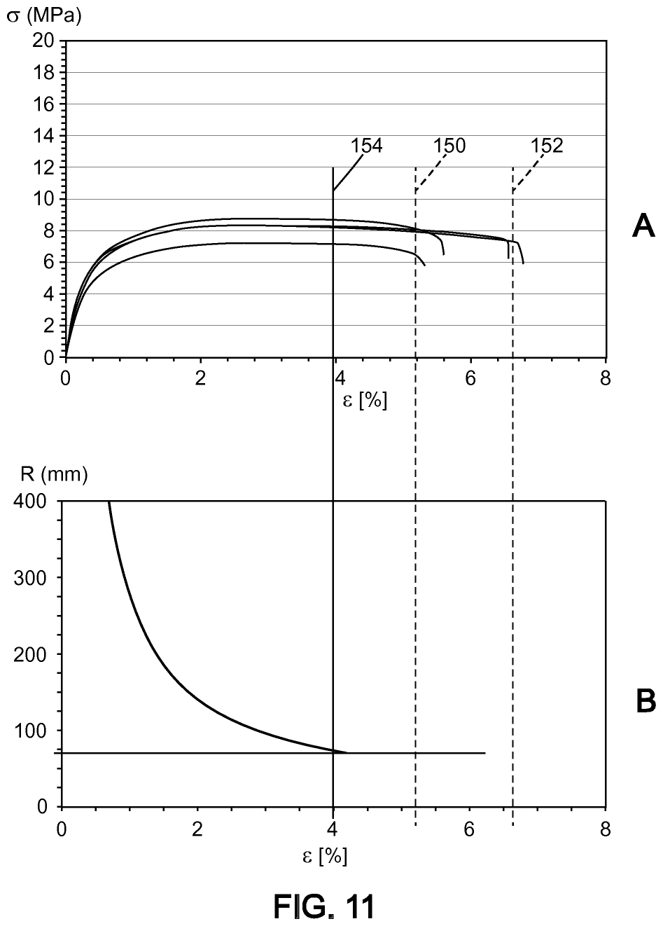

Based on the results of the three-point bending tests illustrated in FIG. 9, it is possible to determine a minimum radius of curvature R that the filament could accept before rupture for a given temperature and in this case for a temperature of 80° C. This is illustrated in FIG. 11.

FIG. 11B illustrates the radius of curvature R of the central roll of the coil in millimeters (mm) as a function of the strain rate e. FIG. 11B is obtained knowing the position of three red dots as illustrated in FIG. 12 during the three-point bending test. A machine records a displacement of the central point 160 and two other support points 162, 164 remain at a fixed position. Thus, it is possible to determine the radius of curvature R of a part illustrated by a curve 166 during the three-point bending test via a small geometric calculation thanks to the positions of the three points 160, 162, 164 and that being so according to the displacement of the central point.

To the extent that these displacements and stresses are recorded throughout the three-point bending test, it is therefore possible to express the radius of curvature R thanks to the displacement of the central point as a function of the stress in the part. Finally, it is possible to plot for each position of the central point which therefore corresponds to a radius of curvature R a curve expressing the radius of curvature R as a function of the strain rate e and thus determine the maximum radius of curvature R acceptable by the filament, as illustrated in FIG. 10B.

Thus, based on the performed calculations, a critical strain rate e that should not be exceeded in order not to damage the filament has been deduced. This critical strain is comprised between 2 and 4% and is preferably lower than 4%. FIG. 11A corresponds to FIG. 6 and allows making the link with FIG. 11B. As illustrated in FIG. 11B, a rupture of the filament occurs between 5.5 and 6.5% as indicated by the two dotted straight lines 150, 152.

The graph in FIG. 11B shows that the greater the strain rate e, the smaller will be the minimum radius of curvature R that should not be exceeded in order not to damage said filament. Under the aforementioned conditions, i.e. with a strain rate lower than 4% as indicated by the limit line 154, the minimum diameter of the central roll of the coil is comprised between 100 and 140 mm and preferably larger than or equal to equal to 120 mm.

1. A method for winding a filament for an additive manufacturing device comprising the steps of:
providing a filament filled with at least 80% metal powder by mass;
heating said filament up to a temperature of at least 70° C. and keeping said filament at said temperature;
winding said filament around the axis of a coil, preferably metallic, the diameter of the coil being in the empty state larger than or equal to a diameter of 100 mm.

2. The method for winding a filament according to claim 1, wherein said diameter of the coil is comprised between 100 and 140 mm, preferably between 120 and 140 mm.

3. The method for winding a filament according to claim 1, wherein said filament is heated to a temperature comprised between 70 and 140° C., preferably between 70 and 90° C.

4. An installation for winding a filament onto a coil for an additive manufacturing device comprising:
a filament extruder;
stretching means;
means for heating and keeping said filament at a temperature of at least 70° C.;
drive means;
means for winding said filament around the coil, preferably metallic, the diameter of the coil of which in the empty state is larger than or equal to a diameter of 100 mm.

5. The installation for winding a filament onto a coil according to claim 4, wherein the means for heating and keeping said filament at a temperature of at least 70° C. intervene between the stretching means and the winding means.

6. The installation for winding a filament onto a coil according to claim 4, wherein the stretching means comprise a drawing belt.

7. The installation for winding a filament onto a coil according to claim 4, wherein the means for heating said filament comprise means for blowing air at said temperature.

8. The installation for winding a filament onto a coil according to claim 4, wherein the means for heating said filament include an infrared heating means.

9. The installation for winding a filament onto a coil according to claim 4, wherein the drive means include at least one drive roller.
